(19) United States
(12) Patent Application Publication
(10) Pub. No.: US 2026/0362531 A1
(43) Pub. Date: Nov. 12, 2026

(54) Methods And Apparatus For RLF Prediction And Early Recovery In Mobile Communications

(71) Applicant: MediaTek Inc., Hsinchu City (TW)

(72) Inventors: Jen-Chien Liu, Hsinchu City (TW); Po-Chien Chou, Hsinchu City (TW); Tz-Yuan Shiu, Hsinchu City (TW); Er-Ya Lee, Hsinchu City (TW); Tsung-Ming Lee, Hsinchu City (TW); Chin-Chia Chang, Hsinchu City (TW)

(73) Assignee: MediaTek Inc., Hsinchu City (TW)

(21) Appl. No.: 19/665,014

(22) Filed: May 1, 2026

Related U.S. Application Data
(60) Provisional application No. 63/802,756, filed on May 9, 2025.

(51) Int. Cl. H04W 76/18; H04L 41/16; H04W 36/36

(52) U.S. Cl. CPC H04W 76/18; H04L 41/16; H04W 36/362

(57) ABSTRACT

Various solutions for radio link failure (RLF) prediction and early recovery between a user equipment (UE) and a network node are described. The UE may predict an occurrence of a radio link failure (RLF). The UE may perform an early recovery procedure in an event that a prediction result of the occurrence of the RLF indicates that the RLF will occur. The early recovery procedure may be performed by a recovery on a layer-1/layer-2 (L1/L2) triggered mobility (LTM) candidate cell or a conditional handover (CHO) candidate cell.

### CROSS REFERENCE TO RELATED PATENT APPLICATION(S)

The present disclosure is part of a non-provisional application claiming the priority benefits of US Patent Application No. 63/802,756, filed on 9 May 2025, the content of which herein being incorporated by reference in its entirety.

### TECHNICAL FIELD

The present disclosure is generally related to mobile communications and, more particularly, to radio link failure (RLF) prediction and early recovery with respect to apparatus in mobile communications.

### BACKGROUND

Unless otherwise indicated herein, approaches described in this section are not prior art to the claims listed below and are not admitted as prior art by inclusion in this section.

In mobile communications, factors such as T310 expiry, radio link control (RLC) maximum retransmission, and random-access channel (RACH) failure may result in RLF. After RLF occurs, the UE may trigger a reestablishment procedure to recover the connection. During the reestablishment procedure, signaling radio bearer 2 (SRB2) and data radio bearer (DRB) are reestablished by a radio resource control (RRC) reconfiguration procedure after the RRC reestablishment is complete. Then, the data transmission is resumed. Before the RLF occurred, the transmission channel may have become worse at transmitting data. However, UE triggers reestablishment until the RLF condition is fulfilled. Therefore, data transmission will pause before meeting the RLF condition and resume once the reestablishment completes and the reconfiguration is received by the UE. In such a procedure, data transmission could experience a long suspension time when RLF occurs.

Accordingly, designing appropriate recovery procedures for the RLF in a new generation communication system has become a critical issue in wireless communication systems, and there is an urgent need to provide such procedures to ensure efficient and reliable operation.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to RLF prediction and early recovery with respect to apparatus in mobile communications.

In one aspect, a method may involve an apparatus predicting an occurrence of an RLF. The method may also involve the apparatus performing a recovery procedure in an event that a prediction result of the occurrence of the RLF indicates that the RLF will occur.

In one aspect, an apparatus may comprise a transceiver which, during operation, wirelessly communicates with a network node. The apparatus may also comprise a processor communicatively coupled to the transceiver. The processor, during operation, may perform operations comprising predicting an occurrence of an RLF. The processor may also perform operations comprising performing a recovery procedure in an event that a prediction result of the occurrence of the RLF indicates that the RLF will occur.

In one aspect, a method may involve an apparatus receiving a request for a recovery procedure from a user equipment (UE) before an RLF is detected by the UE. The method may also involve the apparatus performing the recovery procedure by a fast recovery on a layer-1/layer-2 (L1/L2) triggered mobility (LTM) candidate cell or a conditional handover (CHO) candidate cell.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting example scenarios 100 under schemes in accordance with implementations of the present disclosure.

FIG. 2 is a diagram depicting an example scenario 200 under schemes in accordance with implementations of the present disclosure.

FIG. 3 is a diagram depicting an example scenario 300 under schemes in accordance with implementations of the present disclosure.

FIG. 4 is a diagram depicting an example scenario 400 under schemes in accordance with implementations of the present disclosure.

FIG. 5 is a diagram depicting an example scenario 500 under schemes in accordance with implementations of the present disclosure.

FIG. 6 is a flowchart of an example process in accordance with implementations of the present disclosure.

FIG. 7 is a block diagram of an example communication system in accordance with an implementation of the present disclosure.

FIG. 8 is a flowchart of an example process in accordance with an implementation of the present disclosure.

FIG. 9 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to RLF prediction and early recovery in mobile communications. According to the present disclosure, a number of possible solutions may be implemented separately or jointly. That is, although these possible solutions may be described below separately, two or more of these possible solutions may be implemented in one combination or another.

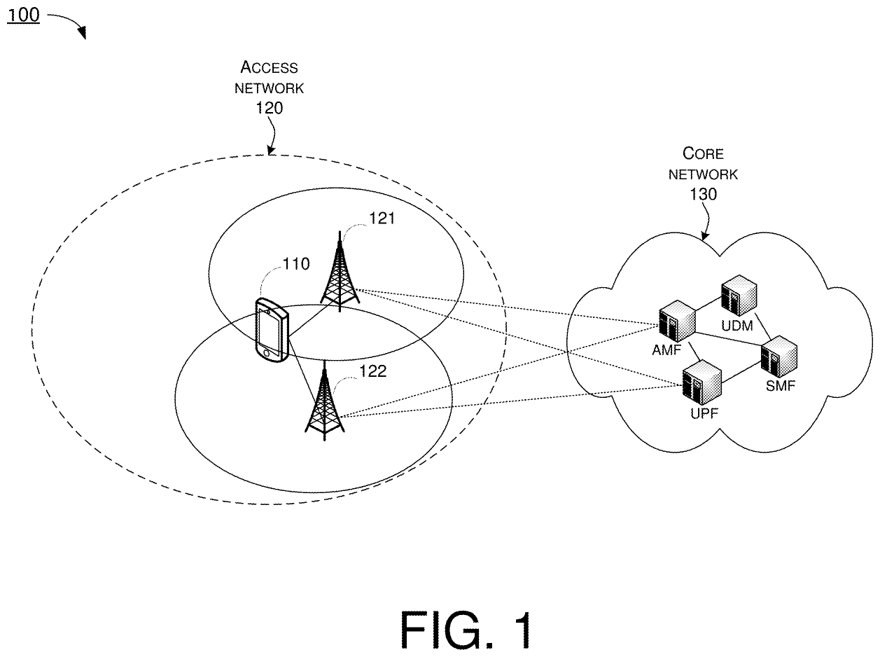

FIG. 1 illustrates an example scenario 100 of a communication environment in which various solutions and schemes in accordance with the present disclosure may be implemented. Scenario 100 involves a user equipment (UE) 110 in wireless communication with a wireless network (e.g., an LTE network, a 5G/NR network, an IoT network, or a 6G network) consisting of an access network 120 and a core network 130. The UE 110 may be a smart phone, a wearable device, an IoT device, a tablet, etc. Alternatively, the UE 110 may be a notebook (NB) or personal computer (PC) inserted or installed with a data card which includes a modem and radio frequency (RF) transceiver(s) to provide the functionality of wireless communication. In one embodiment, the access network 120 is connected to the core network 130 by means of the NG interface, more specifically to a user plane function (UPF) by means of the NG user-plane part (NG-u), and to an access and mobility management function (AMF) by means of the NG control-plane part (NG-c). The access network 120 may include a network node 121 and a network node 122, which may be connected to multiple UPFs/AMFs respectively for the purpose of load sharing and redundancy. The network node may be called a base station (BS) or a cell. In one example, the network node 121 may be a serving cell, and the network node 122 may be a target cell. In addition, the core network may include other entities, such as a session management function (SMF) and a unified data management (UDM), etc. As illustrated, the access network 120 may include multiple BSs (e.g., network nodes 121, 122), each of which may provide communication coverage for a geographic coverage area where communications with the UE 110 are supported. For illustrative purposes, two network nodes (i.e., network nodes 121, 122) and one UE (UE 110) may be described hereinafter. However, it is not intended to limit the network scenarios of the present disclosure.

In mobile communication, data transmission may experience a longer suspension time when RLF occurs. In some cases, the transmission channel may deteriorate before the RLF occurred; however, the UE may be required to initiate a reestablishment procedure until the RLF condition is fulfilled. In some cases, data transmission may pause before meeting the RLF condition and resume once re-establishment is complete, and the UE has received the reconfiguration. In one example, while the UE continues to count N310 consecutive “out-of-sync” events, the DL data has not been successfully decoded; however, the UE may trigger RLF after T310 expiry (the timer may start upon receiving N310 consecutive “out-of-sync”). In one example, numerous UL data have been retransmitted multiple times without reaching the RLC maximum retransmission count. The UL data throughput has dropped to nearly zero in this situation.

Accordingly, various solutions of the present disclosure for RLF prediction are disclosed to avoid poor transmission at the earliest opportunity. In one embodiment, the UE may predict whether the RLF will occur in a short time (e.g., within the next interval T) or the probability of RLF occurrence. In one embodiment, the UE may immediately trigger early recovery procedures by following the methods without waiting for the RLF condition to be met in an event that the UE predicts that the RLF will occur in a short period (time) or the probability of RLF occurrence exceeds a threshold. In one embodiment, the early recovery procedure may be performed without waiting for an RLF condition to be fulfilled. In one embodiment, the occurrence of the RLF may be predicted before an RLF condition is fulfilled. In one embodiment, the early recovery procedure may be performed by a fast LTM/CHO recovery on an LTM candidate cell or a CHO candidate cell. In one embodiment, the early recovery procedure may be performed by sending a measurement report for the target cell to trigger a handover procedure in an event that the target cell is measured and qualified without waiting for a Time-To-Trigger condition to be fulfilled. In one embodiment, the early recovery procedure may be performed by performing re-establishment on the target cell.

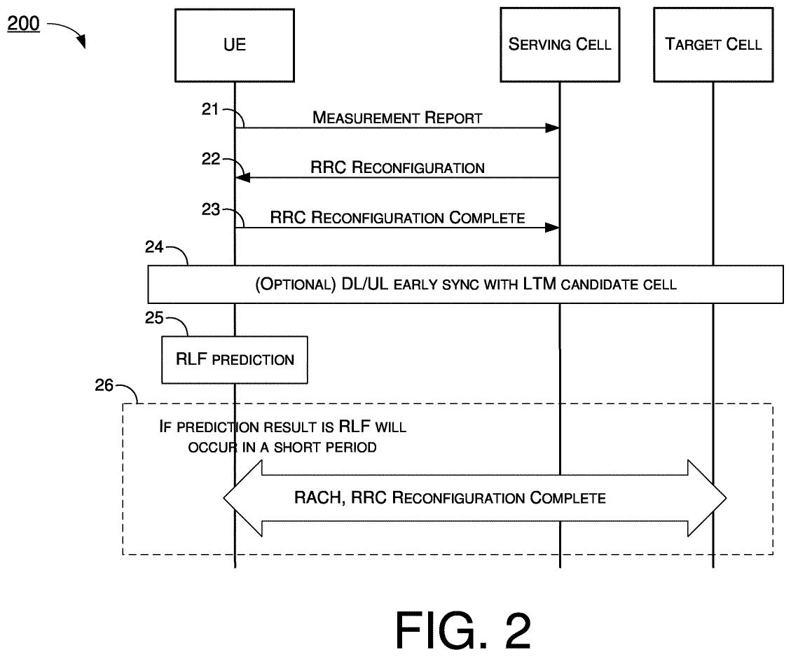

FIG. 2 is a diagram depicting an example scenario 200 of RLF prediction and early recovery in accordance with an implementation of the present disclosure. In one embodiment, as illustrated in FIG. 2, the UE may perform a fast LTM/CHO recovery without waiting for the RLF condition to be met in an event that the network (NW) (e.g., the serving cell) has configured the LTM/CHO configurations and allows the fast recovery. In one example, the UE may perform RACH on the target cell and apply LTM candidate configuration without sending L1/layer-3 (L3) measurement reports and/or receiving an LTM cell switch command in an event that the selected target cell is one of the LTM candidate cells. In one example, the UE may perform RACH on the target cell and proceed with a conditional reconfiguration procedure without checking the conditional event in an event that the selected target cell is one of the CHO candidate cells. In one embodiment, as illustrated in stage 21 of FIG. 2, the UE may transmit a measurement report to the serving cell. At stage 22, the serving cell may transmit an RRC reconfiguration to the UE. The RRC reconfiguration may be an LTM candidate configuration or a CHO candidate configuration. At stage 23, the UE may transmit an RRC reconfiguration complete to the serving cell. Optionally, at stage 24, the UE may perform a downlink (DL)/uplink (UL) early synchronization with an LTM candidate cell. At stage 25, the UE may perform an RLF prediction. At stage 26, the UE may immediately trigger the fast LTM/CHO recovery without waiting for the RLF condition to be met in an event that a prediction result of the RLF prediction indicates that the RLF will occur in a short period (i.e., the UE may immediately perform the early recovery procedure in an event that a prediction result of the RLF prediction indicates that the RLF will occur in a short period). In one example, the early recovery procedure may be performed by a recovery on an LTM candidate cell or a CHO candidate cell. In one example, the recovery on the LTM candidate cell or the CHO candidate cell may be performed in an event that an LTM configuration or a CHO configuration is present, and a selected target cell is the LTM candidate cell or the CHO candidate cell.

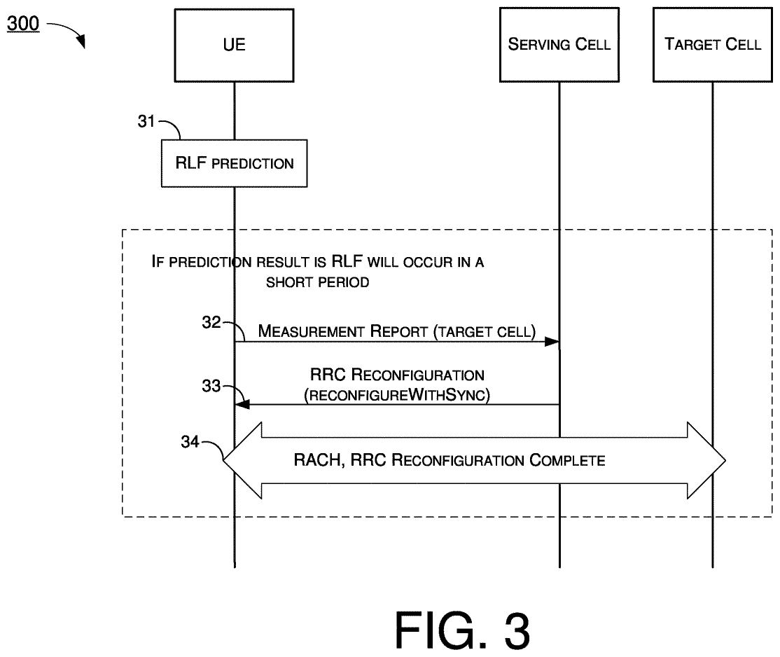

FIG. 3 is a diagram depicting an example scenario 300 of RLF prediction and early recovery under schemes in accordance with implementations of the present disclosure. In one embodiment, as illustrated in FIG. 3, the UE may send a measurement report (e.g., A2, A3, B1, B2 measurement report) to the NW to trigger a handover (HO) procedure without waiting for the Time-To-Trigger condition fulfilled (i.e., without waiting for the RLF condition to be met) in an event that any neighbor cell is measured and its signal strength and/or quality exceeds some predefined thresholds. In one embodiment, as illustrated in stage 31 of FIG. 3, the UE may perform an RLF prediction. At stage 32, the UE may immediately transmit a measurement report for a target cell to the serving cell to trigger an HO procedure in an event that a prediction result of the RLF prediction indicates that the RLF will occur in a short period (i.e., the UE may immediately perform the early recovery procedure in an event that a prediction result of the RLF prediction indicates that the RLF will occur in a short period). In one example, the measurement report may be sent to trigger the handover procedure without waiting for a Time-To-Trigger condition to be fulfilled. In one example, the measurement report may be sent to trigger the handover procedure in an event that the target cell is measured and qualified. At stage 33, the serving cell may transmit an RRC reconfiguration (e.g., reconfigureWithSync) to the UE. At stage 34, the UE may perform RACH on the target cell and complete an RRC reconfiguration procedure with the target cell.

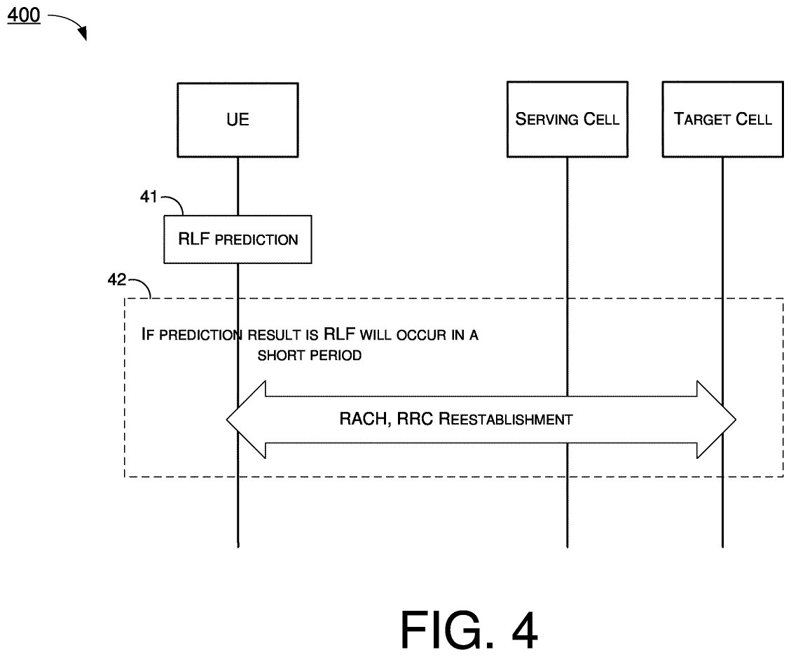

FIG. 4 is a diagram depicting an example scenario 400 under schemes in accordance with implementations of the present disclosure. In one embodiment, as illustrated in FIG. 4, the UE may perform reestablishment procedures without waiting for the RLF condition to be met (only requiring that the UE predicts that the RLF will occur in a short time) in an event that a selected target cell is neither an LTM candidate cell, a CHO candidate cell, nor a measured qualified neighbor cell. In one embodiment, as illustrated in stage 41 of FIG. 4, the UE may perform an RLF prediction. At stage 42, the UE may immediately trigger a re-establishment procedure on the target cell in an event that a prediction result of the RLF prediction indicates that the RLF will occur in a short period (i.e., the UE may immediately perform the early recovery procedure in an event that a prediction result of the RLF prediction indicates that the RLF will occur in a short period). At stage 42, the UE may perform RACH on the target cell and complete RRC re-establishment with the target cell. In one example, the reestablishment procedure may be triggered in an event that the target cell is neither an LTM candidate cell, a CHO candidate cell, nor a measured and qualified neighbor cell.

In some embodiments, the UE may predict the occurrence of the RLF based on key features. The key features may include, but are not limited to, link quality indicators, control flow indicators, scenario flags, or error events. In one example, the occurrence of the RLF may be predicted based on at least one of a link quality indicator, a control flow indicator, a scenario flag, and an error event. In one example, the link quality indicators may be UE measurement results of serving cell and neighbor cell, such as signal-to-noise ratio (SNR), reference signal received power (RSRP), reference signal received quality (RSRQ), signal to interference plus noise ratio (SINR), received signal strength indicator (RSSI), UE transmitted power, downlink/uplink block error rate (BLER), multiple-input multiple-output (MIMO) layer, SR/RX count, etc. In one example, the control flow indicators may be, but are not limited to, A3, A4, A5, B1, and B2 event configurations. In one example, the scenario flag may include, but is not limited to, a high-speed train, which may increase sensitivity to detect RLF when the UE is on a high-speed train. In one example, the error events may include, but are not limited to, measurement report fail count, hybrid automatic repeat request (HARQ) negative acknowledgment (NACK) ratio, radio link control (RLC) retransmission count, random access (RA) error count, etc.

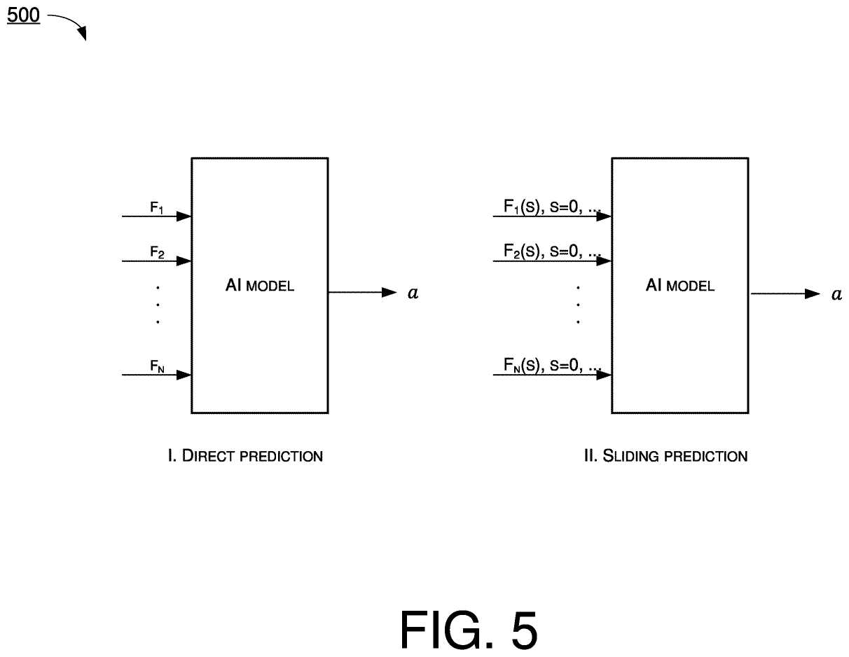

In some embodiments, the occurrence of the RLF may be predicted (i.e., the prediction method may be) based on an artificial intelligence (AI) based prediction. FIG. 5 is a diagram depicting an example scenario 500 under schemes in accordance with implementations of the present disclosure. As illustrated in FIG. 5, the AI-based prediction may be a direct prediction or a sliding prediction. In some embodiments, the UE may use a versatile neural network architecture that integrates various advanced techniques to optimize performance for classification tasks, and the AI model for RLF prediction may include, but is not limited to, long short-term memory (LSTM), recurrent neural network (RNN), and convolutional neural network (CNN). As illustrated in FIG. 5, for direct prediction, the UE may use key features (f₁, f₂, . . . , f ₙ) as inputs of the AI model and predict the occurrence of RLF a. For sliding prediction, the UE may monitor the key features (f₁(s), f₂(s), . . . , fₙ(s)) for X milliseconds (e.g., 500 ms) as inputs of the AI model and predict that the RLF will occur within a short period of Y seconds (e.g., 2 seconds).

In some embodiments, the occurrence of the RLF may be predicted (i.e., the prediction method may be) based on a rule-based prediction. In some embodiments, the RLF prediction may be performed by predefining a threshold or criterion for each key feature and examining each key feature that exceeds the threshold or fulfills the criterion (e.g., RSRP <-110 dBm). The UE may assume the RLF will occur shortly in an event that there are more than X (X may be an integer larger than 1) features that exceed the threshold or fulfill the criterion.

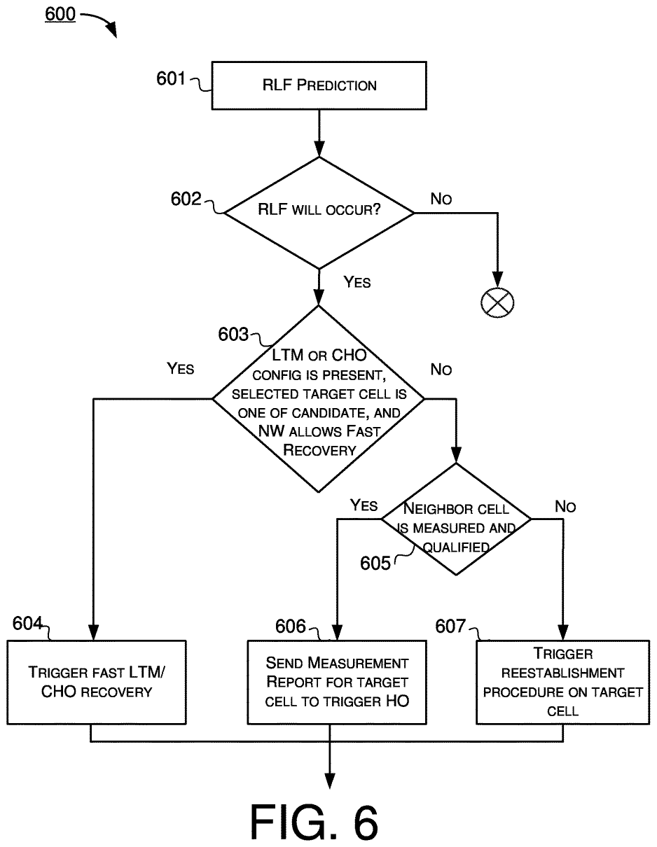

FIG. 6 is a diagram depicting a process 600 of RLF prediction and early recovery in accordance with an implementation of the present disclosure. In some implementations, the procedure may proceed from step 601 to step 604. In some implementations, the procedure may proceed from step 601 to step 606. In some implementations, the procedure may proceed from step 601 to step 607.

In step S601, the UE 110 may begin performing an RLF prediction.

In step S602, the UE 110 may determine whether an RLF will occur (in a short period, e.g., shorter than a threshold). If yes, process 600 proceeds to S603.

In step S603, the UE 110 may determine whether a condition is met. In some implementations, the condition may be that an LTM or CHO configuration is present and that a selected target cell is among the candidate cells. In some implementations, the condition may comprise at least one of that an LTM or CHO configuration is present, a selected target cell is among the candidate cells (e.g., LTM candidate cells or CHO candidate cells), and the NW allows a fast recovery (e.g., the LTM or CHO configuration indicates allowing the fast recovery). If yes, process 600 to S604; otherwise, process 600 to S605.

In step S604, the UE 110 may trigger a fast LTM/CHO recovery.

In step S605, the UE 110 may determine whether a neighbor cell is measured and qualified. If yes, process 600 to S606; otherwise, process 600 to S607.

In step S606, the UE 110 may send a measurement report for the target cell to trigger an HO procedure.

In step S607, the UE 110 may trigger a reestablishment procedure on the target cell.

### Illustrative Processes

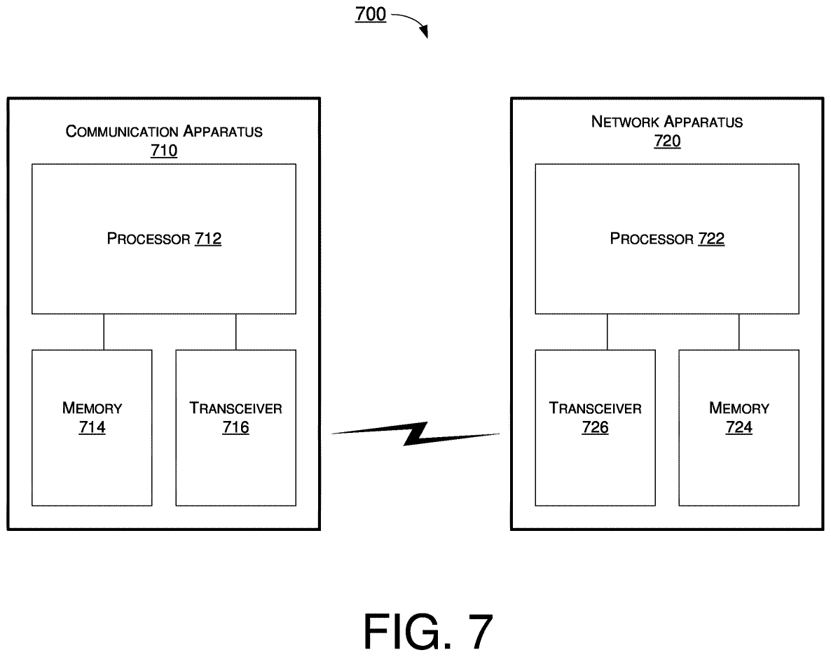

FIG. 7 illustrates an example communication system 700 having an example communication apparatus 710 and an example network apparatus 720 in accordance with an implementation of the present disclosure. Each of communication apparatus 710 and network apparatus 720 may perform various functions to implement schemes, techniques, processes and methods described herein pertaining to RLF prediction and early recovery with respect to UE and network apparatus in mobile communications, including scenarios/schemes described above as well as processes 800, 900 and 1000 described below.

Communication apparatus 710 may be a part of an electronic apparatus, which may be a UE such as a portable or mobile apparatus, a wearable apparatus, a wireless communication apparatus or a computing apparatus. For instance, communication apparatus 710 may be implemented in a smartphone, a smartwatch, a personal digital assistant, a digital camera, or a computing equipment such as a tablet computer, a laptop computer or a notebook computer. Communication apparatus 710 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 710 may be implemented in a smart thermostat, a smart fridge, a smart door lock, a wireless speaker or a home control center. Alternatively, communication apparatus 710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 710 may include at least some of those components shown in FIG. 7 such as a processor 712, for example. Communication apparatus 710 may further include one or more other components not pertinent to the proposed scheme of the present disclosure (e.g., internal power supply, display device and/or user interface device), and, thus, such component(s) of communication apparatus 710 are neither shown in FIG. 7 nor described below in the interest of simplicity and brevity.

Network apparatus 720 may be a part of a network apparatus, which may be a network node such as a satellite, a base station, a small cell, a router or a gateway. For instance, network apparatus 720 may be implemented in an eNodeB in an LTE network, in a gNB in a 5G/NR, IoT, NB-IoT or IIoT network or in a satellite or base station in a 6G network. Alternatively, network apparatus 720 may be implemented in the form of one or more IC chips such as, for example and without limitation, one or more single-core processors, one or more multi-core processors, or one or more RISC or CISC processors. Network apparatus 720 may include at least some of those components shown in FIG. 7 such as a processor 722, for example. Network apparatus 720 may further include one or more other components not pertinent to the proposed scheme of the present disclosure (e.g., internal power supply, display device and/or user interface device), and, thus, such component(s) of network apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged and configured to perform specific tasks including RLF prediction and early recovery in a device (e.g., as represented by communication apparatus 710) and a network (e.g., as represented by network apparatus 720) in accordance with various implementations of the present disclosure.

In some implementations, communication apparatus 710 may also include a transceiver 716 coupled to processor 712 and capable of wirelessly transmitting and receiving data. In other words, processor 712 may transceive the data such as configuration, message, signal, information, indicator, etc. via transceiver 716. Transceiver 716 may include an MR and an LR. In some implementations, communication apparatus 710 may further include a memory 714 coupled to processor 712 and capable of being accessed by processor 712 and storing data therein. In some implementations, network apparatus 720 may also include a transceiver 726 coupled to processor 722 and capable of wirelessly transmitting and receiving data. In other words, processor 722 may transceive the data such as configuration, message, signal, information, indicator, etc. via transceiver 726. In some implementations, network apparatus 720 may further include a memory 724 coupled to processor 722 and capable of being accessed by processor 722 and storing data therein. Accordingly, communication apparatus 710 and network apparatus 720 may wirelessly communicate with each other via transceiver 716 and transceiver 726, respectively. To aid better understanding, the following description of the operations, functionalities and capabilities of each of communication apparatus 710 and network apparatus 720 is provided in the context of a mobile communication environment in which communication apparatus 710 is implemented in or as a communication apparatus or a UE and network apparatus 720 is implemented in or as a network node of a communication network.

In some implementations, each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 714 and memory 724 may include a type of read-only memory (ROM) such as mask ROM, programmable ROM (PROM), erasable programmable ROM (EPROM) and/or electrically erasable programmable ROM (EEPROM). Alternatively, or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

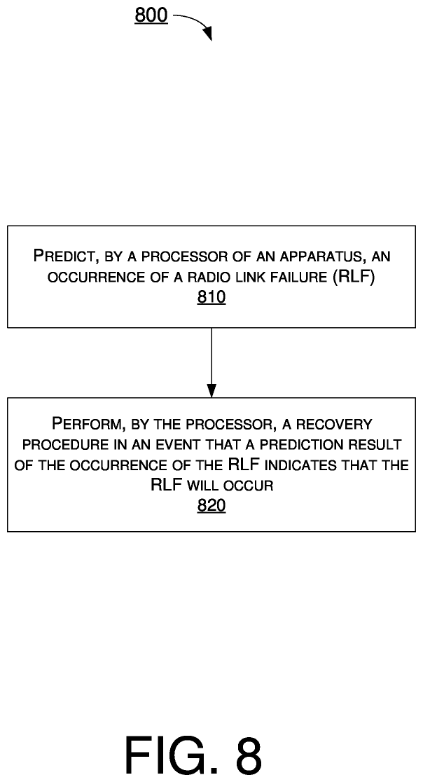

FIG. 8 illustrates an example process 800 in accordance with an implementation of the present disclosure. Process 800 may be an example implementation of above scenarios/schemes, whether partially or completely, with respect to RLF prediction and early recovery of the present disclosure. Process 800 may represent an aspect of implementation of features of communication apparatus 710. Process 800 may include one or more operations, actions, or functions as illustrated by one or more of blocks 810 to 820. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by communication apparatus 710 or any suitable UE or machine type devices. Solely for illustrative purposes and without limitation, process 800 is described below in the context of communication apparatus 710. Process 800 may begin at block 810.

At block 810, process 800 may involve processor 712 of communication apparatus 710 predicting, by a processor of an apparatus, an occurrence of an RLF. Process 800 may proceed from block 810 to block 820.

At block 820, process 800 may involve processor 712 of communication apparatus 710 performing a recovery procedure in an event that a prediction result of the occurrence of the RLF indicates that the RLF will occur.

In some implementations, the recovery procedure is performed by a fast recovery on an LTM candidate cell or a CHO candidate cell.

In some implementations, the recovery on the LTM candidate cell or the CHO candidate cell is performed in an event that an LTM configuration or a CHO configuration is present, and a selected target cell is the LTM candidate cell or the CHO candidate cell.

In some implementations, the recovery on the LTM candidate cell or the CHO candidate cell is performed in an event that an LTM configuration or a CHO configuration is present, a selected target cell is one of the LTM candidate cell or the CHO candidate cell, and the LTM configuration or the CHO configuration indicates allowing the fast recovery.

In some implementations, the performing of the recovery procedure may include sending a measurement report for a target cell to trigger a handover procedure.

In some implementations, the measurement report is sent to trigger the handover procedure, considering an entering condition to be fulfilled, irrespective of the Time-To-Trigger. In some implementations, the entering condition comprises that the target cell is measured and qualified.

In some implementations, the performing of the recovery procedure may include triggering a reestablishment procedure on a target cell.

In some implementations, the reestablishment procedure is triggered in an event that the target cell is neither an LTM candidate cell, a CHO candidate cell, nor a measured and qualified neighbor cell.

In some implementations, the reestablishment procedure is triggered in an event that a fast recovery on an LTM candidate cell or a CHO candidate cell is not performed under a given condition, and no qualified cell is available in configured measurement objects for sending a measurement report to trigger a handover procedure.

In some implementations, the given condition may comprise at least one of the following: that the LTM configuration or the CHO configuration is not present; that a selected target cell is not the LTM candidate cell or the CHO candidate cell; and that fast recovery is not allowed by network apparatus 720.

In some implementations, the occurrence of the RLF is predicted based on at least one of a link quality indicator, a control flow indicator, a scenario flag, and an error event.

In some implementations, the occurrence of the RLF is predicted based on an AI based prediction or a rule-based prediction.

In some implementations, the recovery procedure is performed without waiting for an RLF condition to be fulfilled.

In some implementations, the occurrence of the RLF is predicted before an RLF condition is fulfilled.

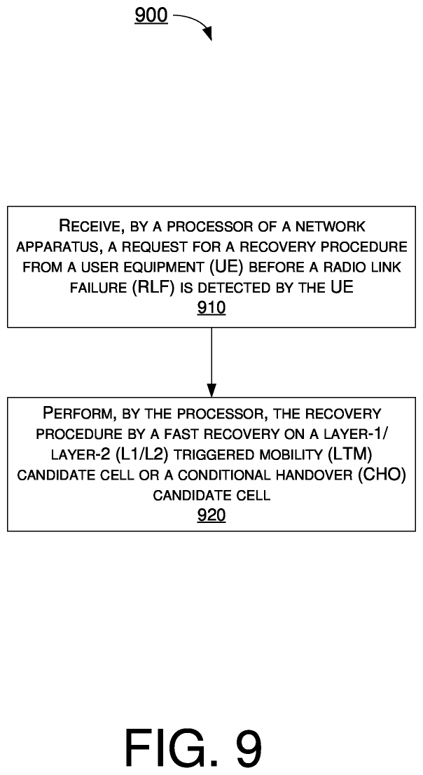

FIG. 9 illustrates an example process 900 in accordance with an implementation of the present disclosure. Process 900 may be an example implementation of above scenarios/schemes, whether partially or completely, with respect to RLF prediction and early recovery of the present disclosure. Process 900 may represent an aspect of implementation of features of network apparatus 720. Process 900 may include one or more operations, actions, or functions as illustrated by one or more of blocks 910 to 920. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by network apparatus 720 or any suitable network device or machine type devices. Solely for illustrative purposes and without limitation, process 900 is described below in the context of network apparatus 720. Process 900 may begin at block 910.

At block 910, process 900 may involve processor 722 of network apparatus 720 receiving a request for a recovery procedure from communication apparatus 710 before an RLF is detected by communication apparatus 710. Process 900 may proceed from block 910 to block 920.

At block 920, process 900 may involve processor 722 of network apparatus 720 performing the recovery procedure by a recovery on an LTM candidate cell or a CHO candidate cell.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
predicting, by a processor of an apparatus, an occurrence of a radio link failure (RLF); and
performing, by the processor, a recovery procedure in an event that a prediction result of the occurrence of the RLF indicates that the RLF will occur.

2. The method of claim 1, wherein the recovery procedure is performed by a fast recovery on a layer-1/layer-2 (L1/L2) triggered mobility (LTM) candidate cell or a conditional handover (CHO) candidate cell.

3. The method of claim 2, wherein the recovery on the LTM candidate cell or the CHO candidate cell is performed in an event that an LTM configuration or a CHO configuration is present, a selected target cell is one of the LTM candidate cell or the CHO candidate cell, and the LTM configuration or the CHO configuration indicates allowing the fast recovery.

4. The method of claim 1, wherein the performing of the recovery procedure comprises:
sending, by the processor, a measurement report for a target cell to trigger a handover procedure.

5. The method of claim 4, wherein the measurement report is sent considering an entering condition to be fulfilled irrespective of the Time-To-Trigger.

6. The method of claim 5, wherein the entering condition comprises that the target cell is measured and qualified.

7. The method of claim 1, wherein the performing of the recovery procedure comprises:
triggering, by the processor, a reestablishment procedure on a target cell.

8. The method of claim 7, wherein the reestablishment procedure is triggered in an event that a fast recovery on a layer-1/layer-2 (L1/L2) triggered mobility (LTM) candidate cell or a conditional handover (CHO) candidate cell is not performed according to a condition, and no qualified cell is available in configured measurement objects for sending a measurement report to trigger a handover procedure; and
wherein the condition comprises at least one of the following:
an LTM configuration or a CHO configuration is not present;
a selected target cell is not the LTM candidate cell or the CHO candidate cell; and
the fast recovery is not allowed by a network node.

9. The method of claim 1, wherein the occurrence of the RLF is predicted based on at least one of a link quality indicator, a control flow indicator, a scenario flag, and an error event.

10. The method of claim 1, wherein the occurrence of the RLF is predicted based on an artificial intelligence (AI) based prediction or a rule-based prediction.

11. The method of claim 1, wherein the recovery procedure is performed without waiting for an RLF condition to be fulfilled.

12. The method of claim 1, wherein the occurrence of the RLF is predicted before an RLF condition is fulfilled.

13. An apparatus, comprising:
a transceiver, during operation, wirelessly communicates with a wireless network; and
a processor communicatively coupled to the transceiver such that, during operation, the processor performs operations comprising:
predicting an occurrence of a radio link failure (RLF); and
performing a recovery procedure in an event that a prediction result of the occurrence of the RLF indicates that the RLF will occur.

14. The apparatus of claim 13, wherein the recovery procedure is performed by a fast recovery on a layer-1/layer-2 (L1/L2) triggered mobility (LTM) candidate cell or a conditional handover (CHO) candidate cell.

15. The apparatus of claim 14, wherein the recovery on the LTM candidate cell or the CHO candidate cell is performed in an event that an LTM configuration or a CHO configuration is present, a selected target cell is one of the LTM candidate cell or the CHO candidate cell, and the LTM configuration or the CHO configuration indicates allowing the fast recovery.

16. The apparatus of claim 13, wherein the performing of the recovery procedure comprises sending a measurement report for a target cell to trigger a handover procedure.

17. The apparatus of claim 16, wherein the measurement report is sent considering an entering condition to be fulfilled irrespective of the Time-To-Trigger, wherein the entering condition comprises that the target cell is measured and qualified.

18. The apparatus of claim 13, wherein the performing of the recovery procedure comprises triggering a reestablishment procedure on a target cell.

19. The apparatus of claim 13, wherein the occurrence of the RLF is predicted based on at least one of a link quality indicator, a control flow indicator, a scenario flag, and an error event.

20. A method, comprising:
receiving, by a processor of a network apparatus, a request for a recovery procedure from a user equipment (UE) before a radio link failure (RLF) is detected by the UE; and
performing, by the processor, the recovery procedure by a fast recovery on a layer-1/layer-2 (L1/L2) triggered mobility (LTM) candidate cell or a conditional handover (CHO) candidate cell.
